(19) United States
(12) Patent Application Publication
(10) Pub. No.: US 2026/0299315 A1
(43) Pub. Date: Oct. 1, 2026

(54) PRISM-FILTER LENSES

(71) Applicant: RANNI PEREIRA SANTOS, Curitiba/PR (BR)

(72) Inventor: RANNI PEREIRA SANTOS, Curitiba/PR (BR)

(21) Appl. No.: 19/480,511

(22) PCT Filed: May 7, 2024
(86) PCT No.: PCT/BR2024/050187

§ 371 Date: Oct. 31, 2025

(30) Foreign Application Priority Data
May 10, 2023 (BR) 2020230090007

(51) Int. Cl. G02C 7/04; G02C 7/10

(52) U.S. Cl. CPC G02C 7/04; G02C 7/104

(57) ABSTRACT

The present utility model relates to prism-filter lenses in the field of ophthalmological medicine, and more specifically to prism lenses combined and joined with medical filters, applied to spectacle frames or intraocular lenses, which allow selective absorption of the visible light spectrum, and can also be combined concomitantly with spherical or cylindrical lenses. The object of the patent enables visual rehabilitation therapy for patients with congenital and/or acquired retinal and optic nerve diseases, allowing them to see clearly, with a continuous gain in lines of sight over time. There may be variations in prism dioptre, spherical dioptre, cylindrical dioptre, and medical filter applied, suitable for each patient according to the diagnosis of the pathology identified during the ophthalmological examination, being joined together in a single block (prism lens with medical filter tinting, with or without the joining of spherical or cylindrical lenses), which will make up the lens.

### FIELD

The present utility model is applicable to the field of ophthalmological medicine and refers to a filtering prismatic lens applied to eyeglasses, intraocular lenses, or contact lenses, consisting of a prismatic lens block with the application of medicinal filter tinting, having the function of visual rehabilitation for patients with low vision and/or blindness due to irreversible etiologies, allowing them to see clearly through the use of the object.

### BACKGROUND

Visual rehabilitation is a field of medicine that provides optical resources and aids to assist blind and low-vision patients in achieving an improvement in both the quality and quantity of functional vision.

Visual rehabilitation seeks to restore abnormalities in ocular movement, such as various forms of strabismus, whether or not accompanied by nystagmus (rapid and involuntary eye movement) and amblyopia (low vision without structural lesion). For visual rehabilitation, prismatic lenses and filtering lenses are already used separately, alleviating visual difficulties but not completely resolving the problem.

Prismatic lenses are optical systems that disperse and deflect light. They are normally used to deviate light in different ways, according to each user's needs and the magnitude of the required compensation. They displace the image and act by compensating for a residual visual field with magnification of the perceived image and displacement toward the visual axis. They also enable alignment and strengthening of the extrinsic ocular muscles, which are weakened and misaligned in low-vision conditions, and consequently correct diplopia, nystagmus, and ocular deviations as well.

Filtering lenses are tinted lenses with the property of allowing the passage of light within a specific wavelength range. They are also referred to as medicinal filters, as they absorb part of the light spectrum and stimulate the retinal photoreceptor cells, which are affected by various retinal diseases. The filtering lens provides higher visual resolution through glare reduction or increased contrast sensitivity, offering the patient greater visual comfort and image sharpness. There are ocular conditions in which the selective absorption of the visible light spectrum improves visual function, such as in degenerative retinal diseases, neurological disorders, and decreased transparency of the optical media.

The benefit of using these lenses separately in eyeglasses is already widely known in the state of the art. However, the present utility model patent relates to the possibility of combining prismatic lenses with medicinal filters for low-vision patients, which results in the displacement of the image from the periphery toward the center, in accordance with the lateralization of the residual visual field, with amplification of this field and improvement of contrast, thus providing better image sharpness and visual quality. This leads to a gain of 2 to 8 lines in distance visual acuity tests, and promotes visual improvement for near vision, enabling greater reading speed.

The present utility model proposes the combination of prismatic lenses with medicinal filters, to be used in eyeglass frames, intraocular lenses, or contact lenses. The prescription method is carried out through a test frame with the assembly of the lens blocks (prisms and medicinal filters) in question, with the possibility of combining spherical and cylindrical lenses (in certain cases). The combination of medicinal filter lenses with prismatic lenses provides an even more significant improvement in vision for individuals with low vision and/or blindness caused by irreversible etiologies (congenital and/or acquired diseases of the retina, optic nerve, and visual cortex).

Filtering prismatic lenses are optical lenses composed of prisms with medicinal filter tinting, which may or may not include the combination of spherical and cylindrical lenses in their composition block. The combination of prismatic lenses and the medicinal filter stimulates the retina and the optic pathways, promoting neuroplasticity and possible cortical neuromodulation, resulting in a gain of visual lines with improved image sharpness over time, constituting a significant optical aid for visual neurorehabilitation in cases of low vision caused by congenital and/or acquired retinal and optic nerve diseases. These are therapeutic lenses with cortical stimulation function, promoting significant visual rehabilitation.

The prisms used in the utility model are graduated from 01 to 20 prism diopters, and the filters are available in various colors (yellow, brown, red, orange, gray, green, and blue). The prism base is almost always temporal, since it has been observed that the residual visual field in low-vision patients is mostly located in the temporal region of the visual field; however, it may also be positioned nasally or superiorly.

In cases of more advanced blindness, the prismatic lenses may range from 08 prism diopters with a temporal or superior base, combined with medicinal filters (yellow, brown, red, orange, gray, green, and blue), corresponding to the blocking of the specific light spectrum for each pathology causing low vision.

The ophthalmologist, then, using test lenses and medicinal filters in the clinic, identifies the appropriate prism, diopter, and filter for each patient. With a trial frame, the prismatic lens is tested separately in each eye, after the patient's refraction is performed in a phoropter and the best correction is verified through visual acuity measurement. The test is performed in a trial frame with Snellen charts for distance and near vision. Thus, the present utility model unites all indicated lenses and filters for that individual in a single object, combining several lens types in one block (spherical/cylindrical lenses+prism+medicinal filter coloration).

The prism lens is chosen according to the patient's low vision, and the prism base is positioned at the site of residual vision (nasal, temporal, superior, or inferior, with variations). In patients with absolute blindness (no residual vision), the prism is positioned according to the deviation of the extrinsic ocular muscles observed in these patients. Prisms ranged from 1 to 20 prism diopters are used. The medicinal filters chosen to combine with prism lenses in the trial frame come in the following colors according to diagnosed etiologies: brown, red, yellow, orange, green, blue, and gray.

Validation of the chosen combination and the improvement provided by the utility model can be performed through visual acuity measurement, color tests, stereopsis tests, contrast sensitivity tests, visual field examination, and electrophysiological studies (visual evoked potential, PERG, and PHNR).

Prism lenses and medicinal filters, individually considered, already exist in prior art; however, a lens resulting from the combination of these properties (filtering prism lens) in eyeglasses, intraocular lenses, or contact lenses is not currently found or manufactured on the market.

Thus, with regards to the prior art, no device with the same technical characteristics as employed in the present utility model was found that could improve the solution to this problem in the prior art. Therefore, it meets the requirements set forth in Articles 9, 11, and 15 of the Brazilian Industrial Property Law (Law No. 9,279/96).

### DESCRIPTION OF THE DRAWINGS

FIGS. 01 to 04 show the variations in prism positioning, illustrating the filtering prismatic lenses with nasal base, temporal base, superior base, and inferior base, respectively.

FIGS. 05 to 11 show the same variations combined with color variations (yellow, blue, gray, orange, brown, green, red, respectively). Thus, each figure contains four columns of pairs of filtering prismatic lenses: the first representing nasal base lenses, the second temporal base, the third superior base, and the fourth inferior base. Each figure also contains lines demonstrating the variations in the shades of the respective coloration.

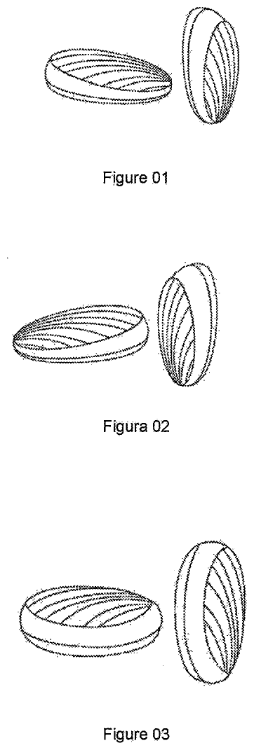

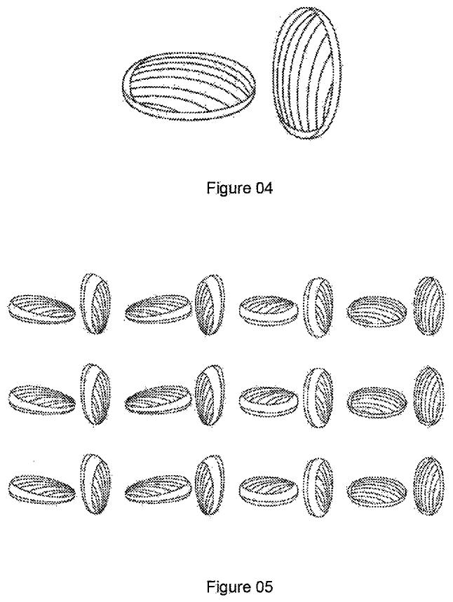

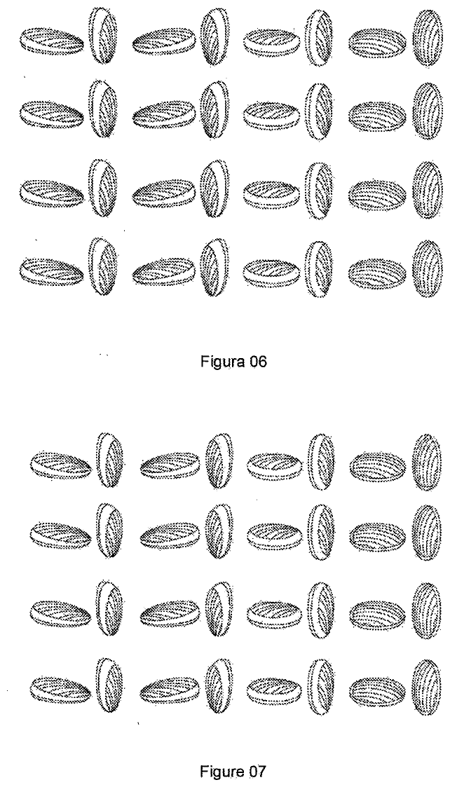

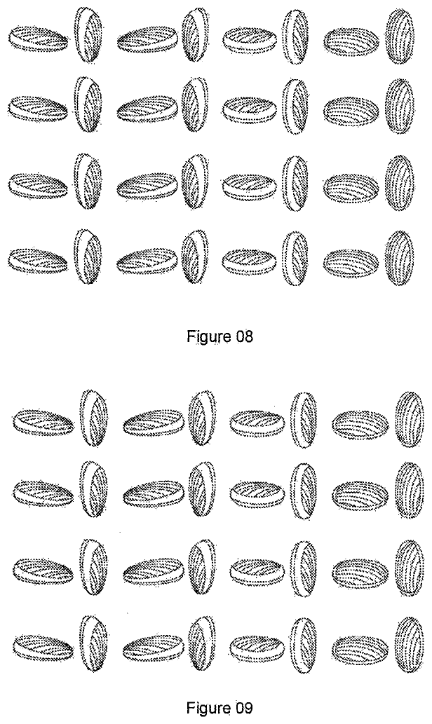

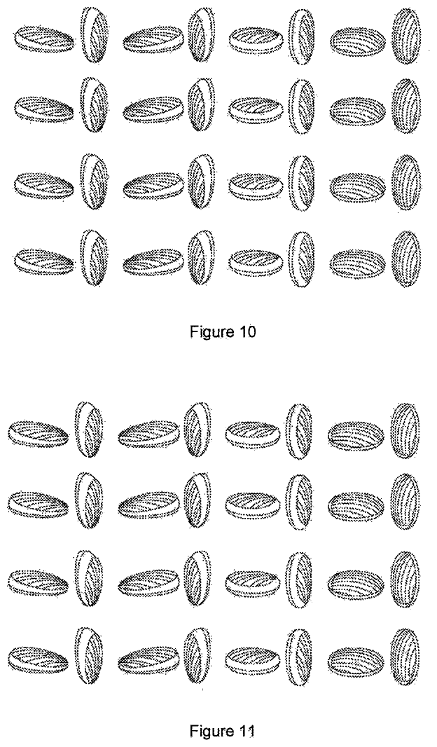

### DESCRIPTION

The filtering prismatic lenses, object of this utility model application, are composed of a lens block, each consisting of a prismatic lens tinted by the application of a medicinal filter, and may additionally include a cylindrical or spherical lens in its manufacturing composition. They may also be produced as intraocular lenses (PMMA or acrylic) or as contact lenses (rigid or hybrid). In summary, there is a combination of various types of specific lenses into a single block (spherical/cylindrical lenses+prism+medicinal filter tinting application), in a form that is not currently manufactured on the market.

Those skilled in the art may, based on the foregoing description, use the present utility model in its broader context, manufacturing eyeglasses with prismatic lenses containing a medicinal filter according to a medical prescription, improving the technique for the process of joining these components into a single block. Any examples provided should be regarded as merely illustrative and not as a limitation of the scope of the present utility model in any way.

1-6. (canceled)

7. A prism-filter lens comprising a block of prism lens applied with a medicinal filter mounted in an eyeglass frame, or manufactured as an intraocular lens or contact lens, wherein the lens comprises a combination and union of a prism lens colored with a medicinal filter that provides selective absorption of the visible light spectrum, united with a prism lens ranging from 1 to 20 prism diopters, manufactured in ophthalmic resin with indices between 1.499 and 1.67, surfaced with optical prisms, with the addition of medicinal filter treatments that may vary in contrast frequencies from 20% to 80% or visible spectrum blocking from 400 to 700 nanometers.

8. The prism-filter lens of claim 7, wherein the lens is additionally composed of a spherical or cylindrical lens block.

9. The prism-filter lens of claim 7, wherein the lens has a medicinal filter incorporated in its composition, in the following colors: brown in 4 shades, red in 4 shades, yellow in 3 shades, orange in 3 shades, green in 3 shades, blue in 3 shades, lilac in 2 shades, pink in 2 shades, and gray in 3 shades.

10. The prism-filter lens of claim 7, wherein the medicinal filter acts to reduce glare or to increase contrast sensitivity.

11. The prism-filter lens of claim 7, wherein the prism lens colored with a medicinal filter is manufactured in resin with a refractive index of either 1.499 or 1.670.

12. The prism-filter lens of claim 7, wherein the lens is applied in the manufacturing of contact lenses comprising rigid gas-permeable with coloring, intraocular lenses comprising PMMA and hydrophilic with coloring, or resin lenses for eyeglass frames.
